(19) United States
(12) Patent Application Publication
(10) Pub. No.: US 2009/0206818 A1
(43) Pub. Date: Aug. 20, 2009

(54) AC VOLTAGE REGULATION SYSTEM AND METHOD

(76) Inventor: Michael J. Horan, Scottsdale, AZ (US)

Correspondence Address: WILLIAM C. CAHILL, 155 PARK ONE, 2141 E. HIGHLAND AVENUE, PHOENIX, AZ, 85016, US

(21) Appl. No.: 11/813,307

(22) PCT Filed: Jan. 3, 2006
(86) PCT No.: PCT/US06/00851

§ 371 Date: May 15, 2008

Related U.S. Application Data
(60) Provisional application No. 60/641,029, filed on Jan. 3, 2005.

(51) Int. Cl. G05B 24/02

(52) U.S. Cl. 323/311

(57) ABSTRACT

Control of the RMS AC voltage applied to the load (Motor) utilizes a switching device (SCR) such as a SCR in series between the load and a power source. A controller (lPController) including a processor and an analog to digital converter is connected to the line voltage and floats at line voltage and detects line voltage cross-over ad the voltage drop across the SCR. Abrupt voltage increases in the voltage across the SCR are used to replace the prior art zero current cross-over to permit the calculation of corrective timing to switch the SCR on at the succeeding voltage wave.

### BACKGROUND

This invention relates to AC voltage regulation systems and more particularly to a regulation system that can be incorporated in single or multiple phase systems in simple household facilities or large factory-type environments. The system is directed to regulating AC voltage to facilitate the efficient utilization of power and reduce wasted power normally present in load systems, particularly reactive load systems.

This invention uses a distributed voltage control system to reduce wasted energy or reduce the total energy consumption for a facility or a single location where energy is consumed. The hardware circuitry is optimized for detection of the control signal used to reduce the applied RMS voltage to meet the requirements of the load.

Single phase applications provide the best starting point to analyze facility wide AC voltage control. These applications can generally be divided into four classifications regarding how the load is seen by the AC voltage source. The first type of load is a resistive load with examples that include the electric heater element in a clothes dryer and the typical incandescent light bulb. These loads are designed for use over a wide range of input voltage and simply provide more heat with higher input voltages. These loads have a near unity power factor and work best when operated at the AC input voltage they were designed for. The second type of load is the common computer or electronics load that uses an AC to DC power supply. These loads have input capacitors that charge to a high DC voltage based on the rectified AC input. The current flows to these loads only during the peaks of the AC voltage sine wave. These loads are designed to work over a wide range of input voltage and are impacted more by the peak AC voltage than the RMS AC voltage. The third type of load is generally the second type with a power factor corrected front end that spreads out the current draw to the entire AC sine wave instead of just the peaks. This load has a near unity power factor and constant true power consumption over the full design range of AC input voltage. It is the fourth load type, the AC induction motor, that makes up the largest percentage of loads and is the most sensitive to varying AC input voltages, and is the principle load used in the description of this invention.

The AC induction motor operates most efficiently when it is fully loaded and connected to the minimum AC input design voltage. Under higher voltages or when the loads are lighter, the efficiency drops off. The power factor also reduces when either of those conditions occurs. Most applications will naturally have loads that vary. The only way to improve the motor efficiency is to vary the applied AC voltage to match the varied load. It is not possible for a utility company to vary the AC voltage to a house or factory based on the changing load requirements of an AC motor. It is possible for this invention to vary the applied RMS voltage to every connected load so that the voltage matches the load demands.

This invention provides AC voltage control at the point of power consumption and it also coordinates voltage and power factor control with other load controllers and a site master controller. One site or facility could be a typical residential home for single phase controllers. The site or facility could also be a large industrial or commercial location where the majority of power used is 3 phase and the single phase power is just a small portion of the total power being consumed.

The present invention may more readily be described by reference to the accompanying drawings in which:

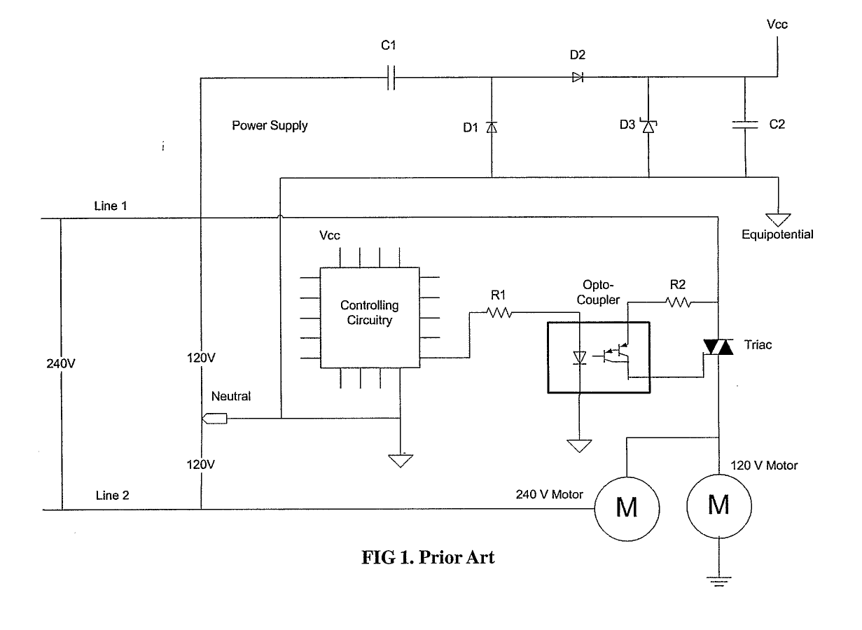

FIG. 1 is a schematic circuit diagram of a prior art AC voltage control system showing the connection of control circuitry in accordance with the prior art.

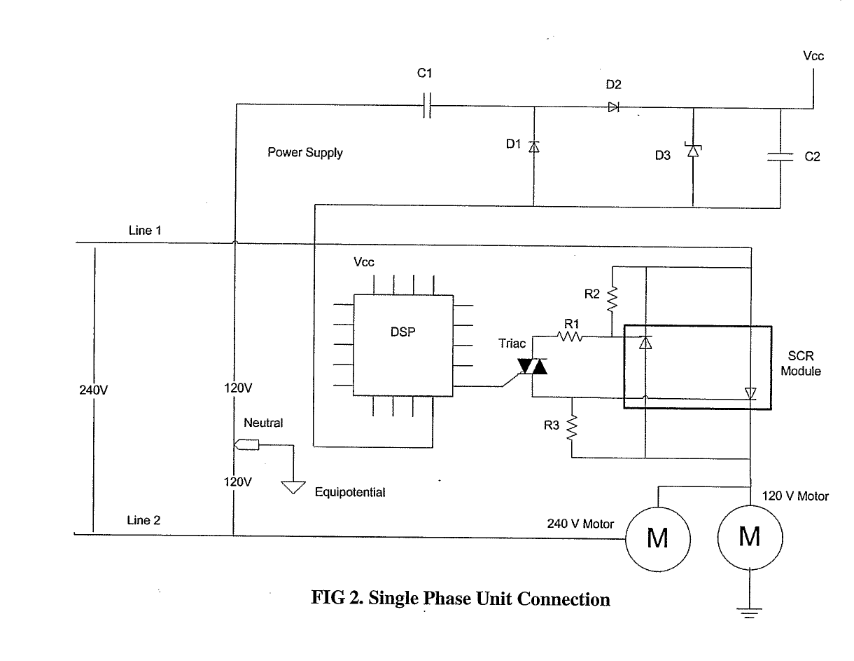

FIG. 2 is a schematic circuit diagram of a system incorporating the teachings of the present invention.

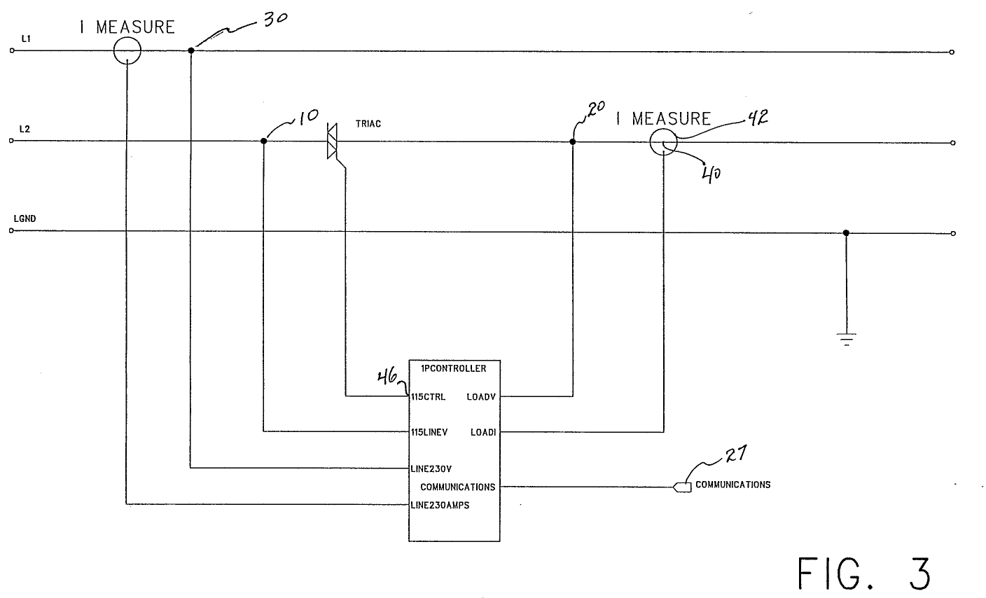

FIG. 3 is a schematic circuit diagram of a single phase implementation of the present invention.

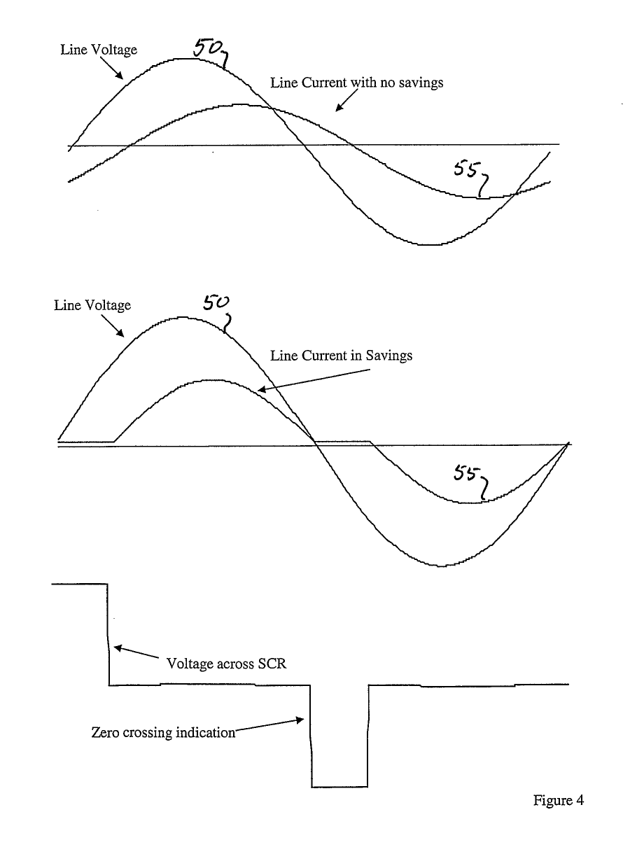

FIG. 4 shows voltage and current wave forms useful in explaining the triggering of the SCR in response to an abrupt voltage increase across the SCR.

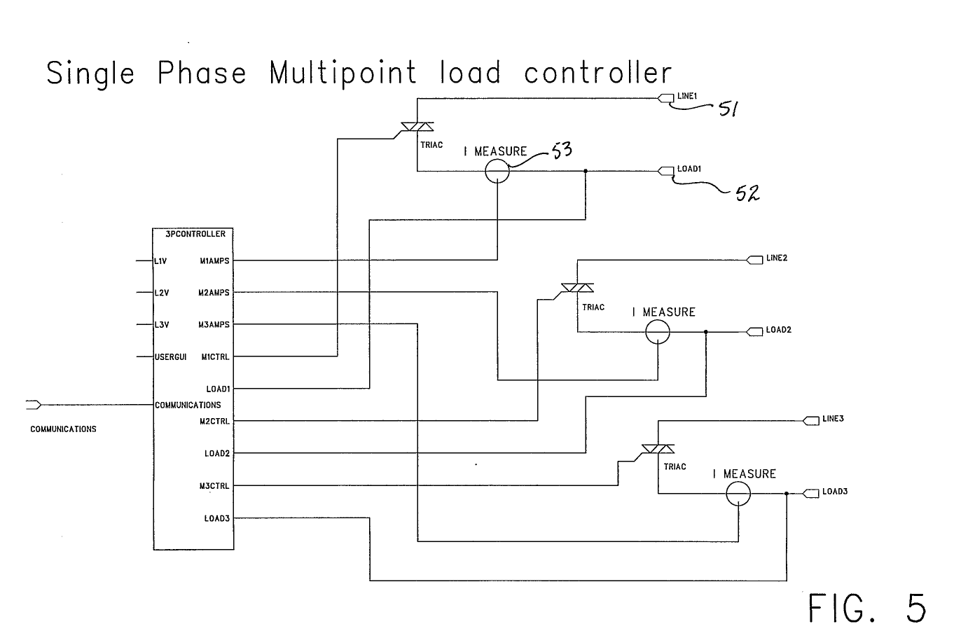

FIG. 5 is a circuit diagram of a single phase system incorporating the teachings of the present invention utilized in the control of multiple loads.

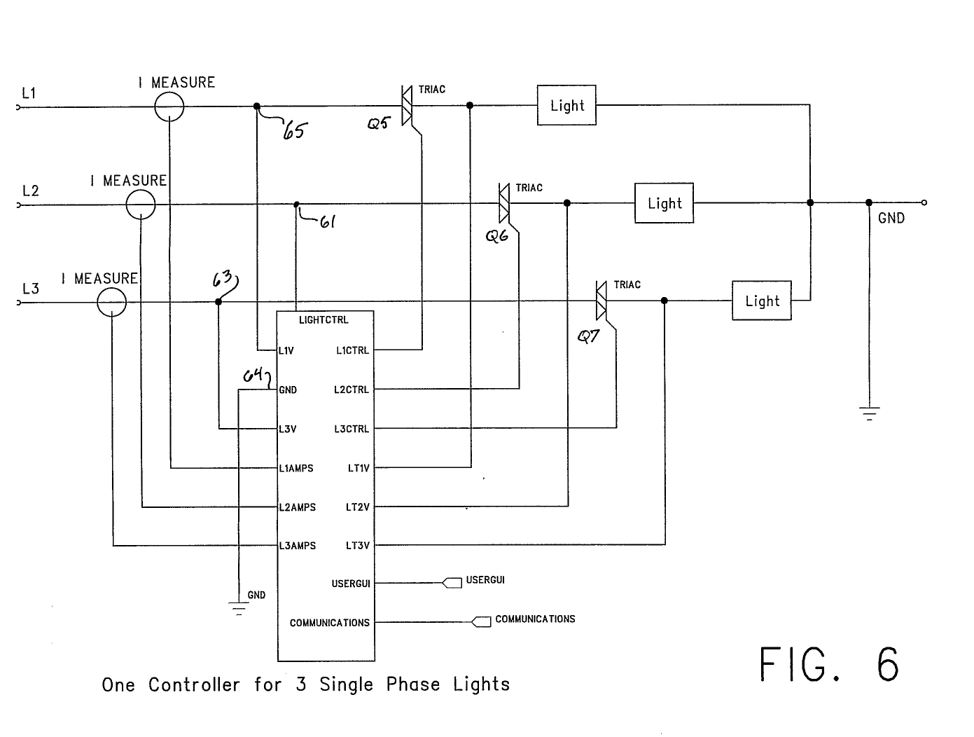

FIG. 6 is a circuit diagram of an implementation of the present invention showing the system incorporated in a light circuit operating on single phase.

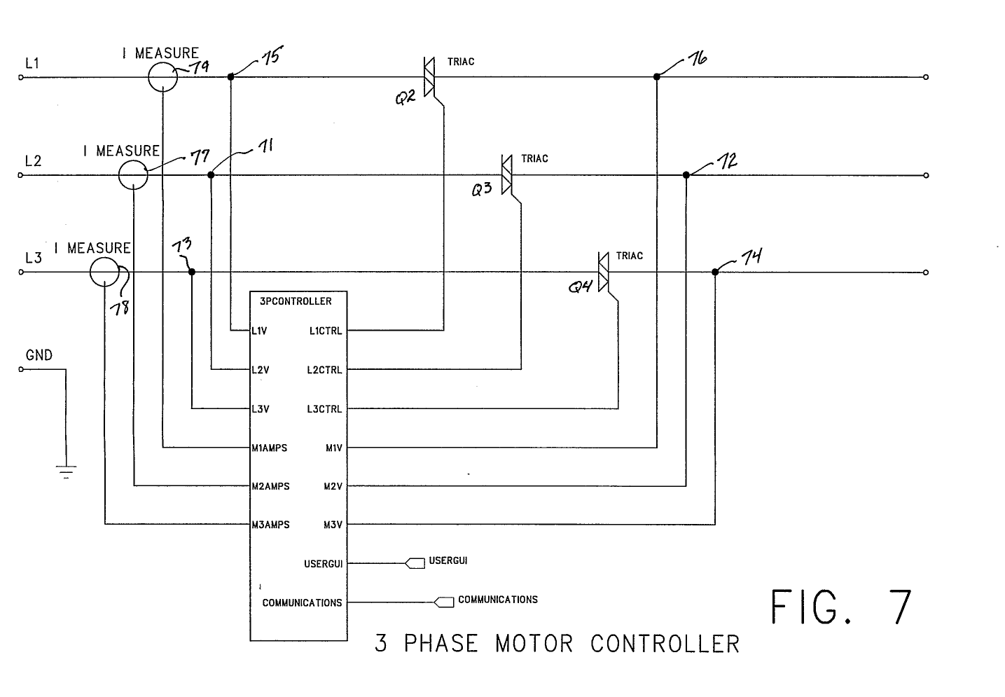

FIG. 7 is a circuit diagram of the implementation of the present invention in a three phase motor circuit.

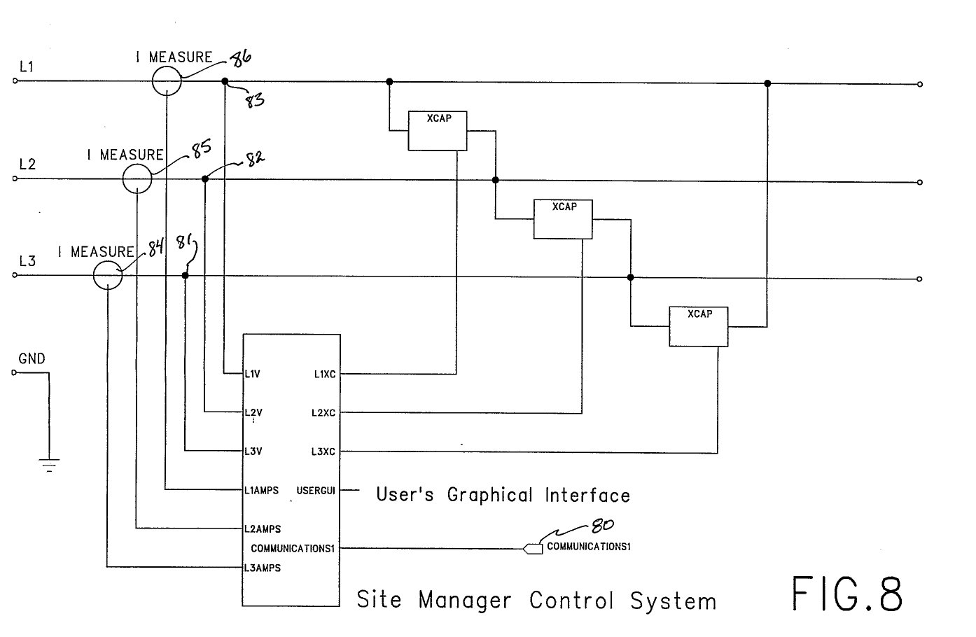

FIG. 8 is a circuit diagram of a site manager control system utilized in the present invention.

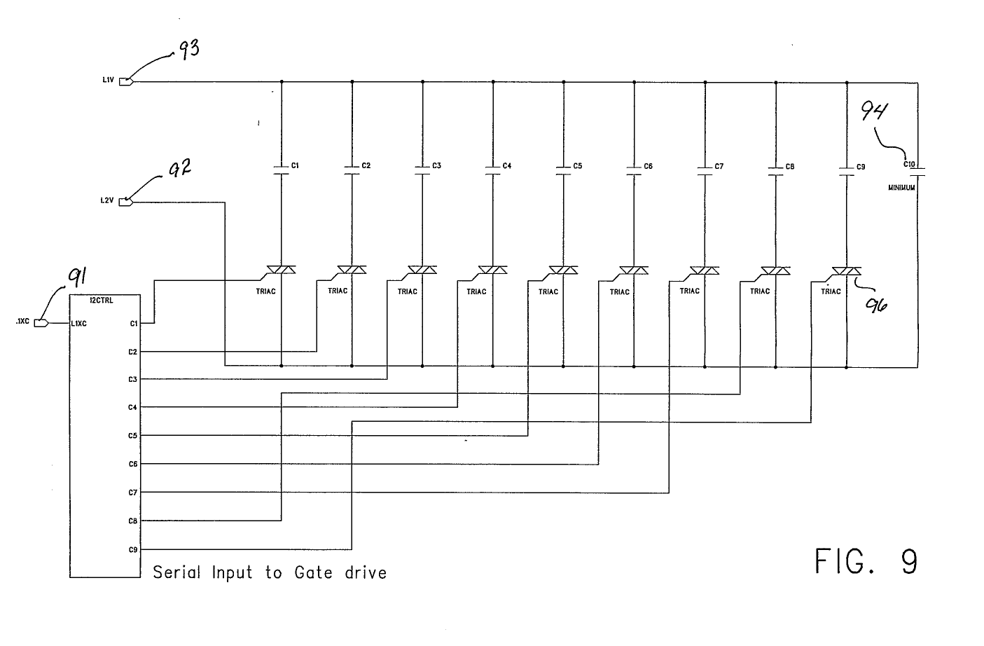

FIG. 9 is a schematic diagram of capacitive supplementation to the system to correct the power factor.

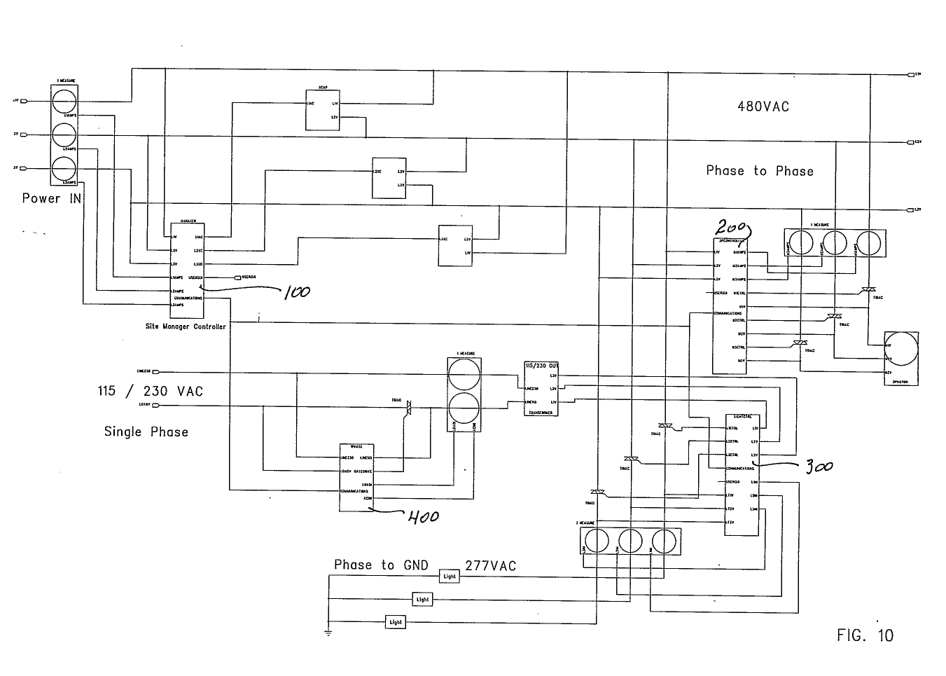

FIG. 10 is a schematic circuit diagram of the present invention embodied in a facility-wide control system.

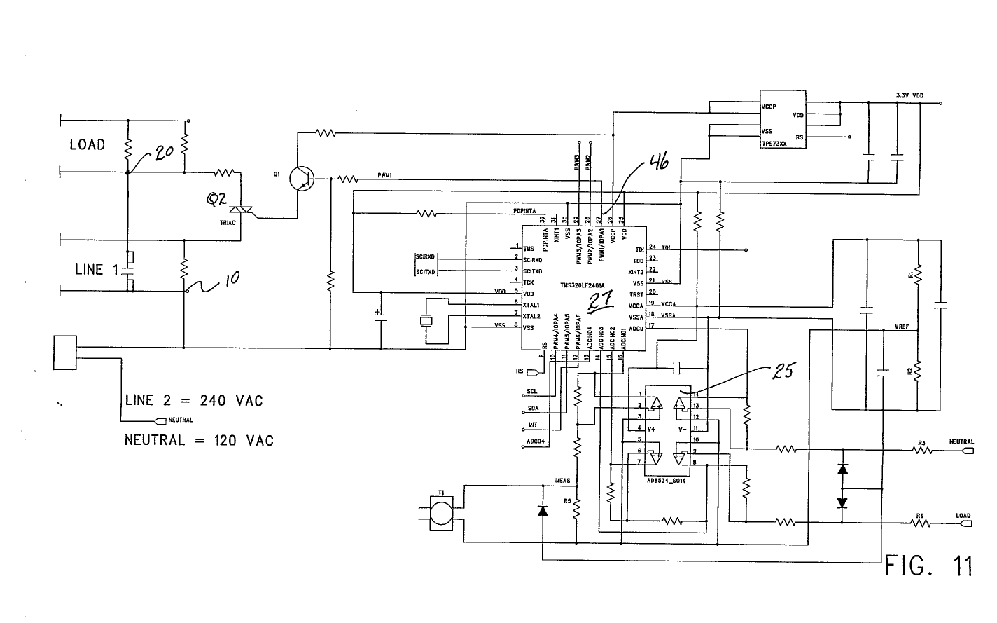

FIG. 11 is a more detailed view of the controller circuitry of the present invention.

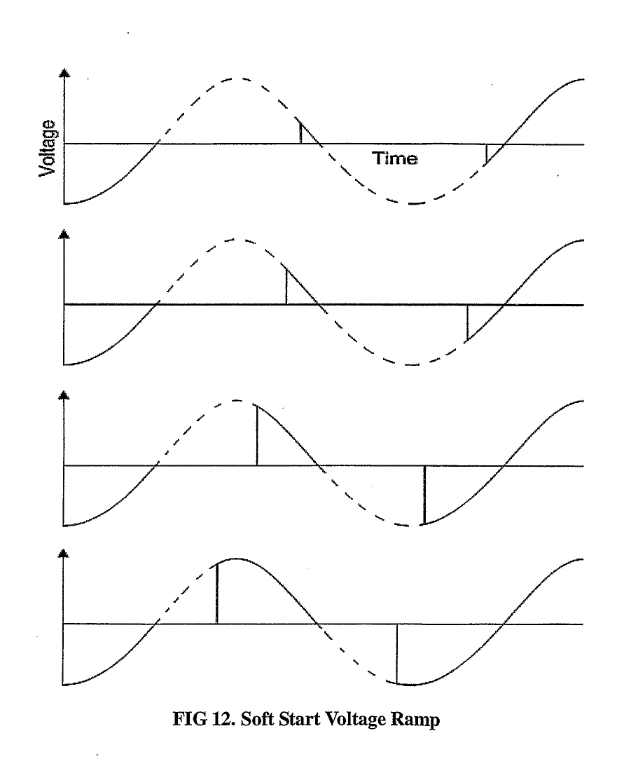

FIG. 12 shows a series of wave forms useful for describing the soft start voltage ramping implemented in the present invention.

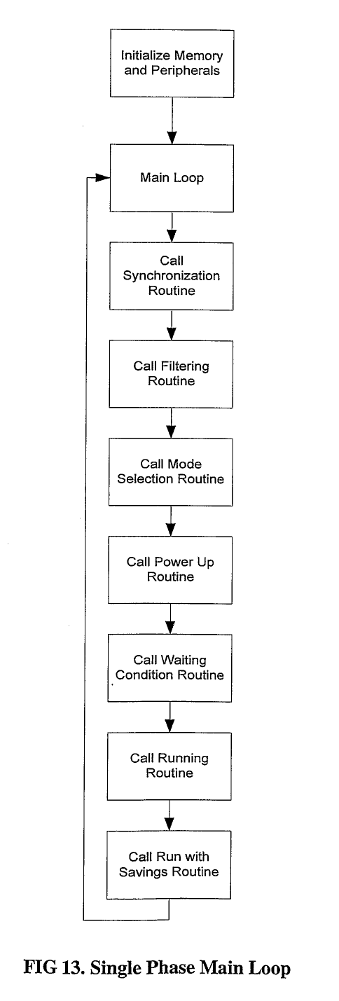

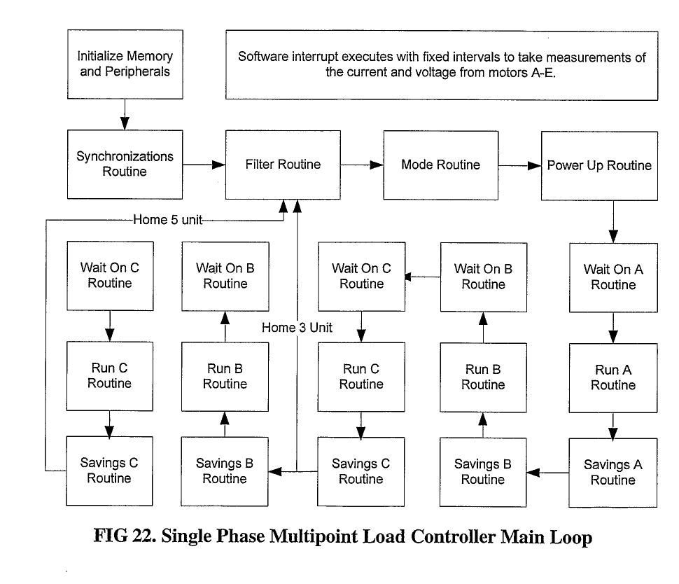

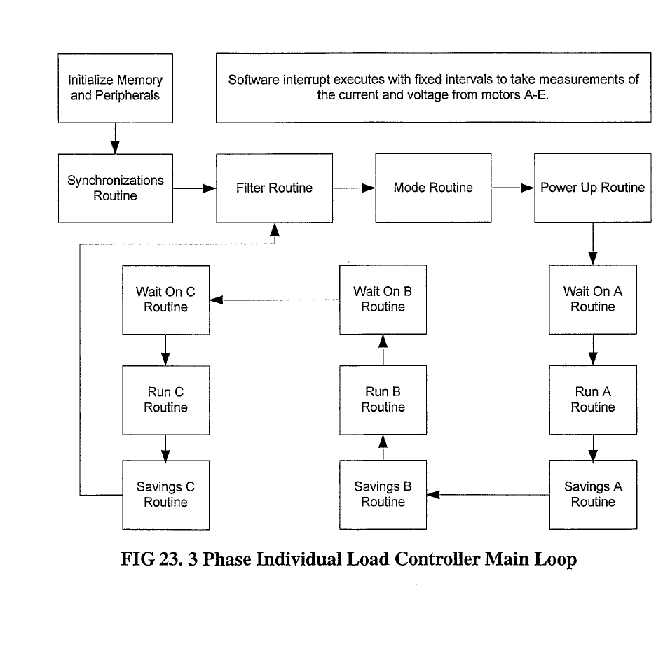

FIGS. 13 through 32 are functional flow diagrams useful for describing the sequencing and operation of the system of the present invention.

The present invention incorporates a power semiconductor device like a thyristor between the AC source and motor load. This is shown in FIG. 3. A TRIAC could be used however; it has been found that having two Silicone Control Rectifier (SCR) devices connected in a parallel inverse configuration works much better for highly inductive AC motors. A small computer with Analog to Digital conversion capabilities and sufficient processing power to handle the math and data processing in real time is used, such as a Texas Instruments Digital Signal Processor. The DSP has internal Analog to Digital converters, runs at 40 MHZ and has an instruction set optimized for advanced mathematical manipulation of data sets. The resultant output of this DSP is the precise timing for when to turn on the power semiconductor device to provide the RMS voltage needed by the load. Analog to Digital conversion is needed for the input voltage, output voltage and the current. It takes the capture and analysis of all three to derive the best RMS voltage for the load.

Current sensing is provided by a typical current sense transformer. This transformer works on a current turns ratio providing an output signal that is equal to a small portion of the current going through the main wire. The output signal must be a true representation of the original signal as the analog value is being sampled about 360 times per full sine wave. This invention uses the actual curvature of the voltage sine wave and zero crossing in calculating the required RMS voltage. A substantial amount of voltage level translation is required between the AC input voltages and the A to D converters. The other area of level converters is from the output of the computer unit to the power SCR modules. A power supply is also needed to provide the DC voltage used by the computer unit (DSP) as well as for the level translation which is the final functional hardware item needed for this invention.

In prior art systems, working with single phase power is accomplished by placing the sensitive computer and A to D conversion circuitry at a Neutral or ground potential. For 240VAC applications in the US, Neutral is ground potential between the 2 line voltages. Then the power switching device is located in either Hot line.

When the control circuit is placed at Neutral potential and the power device placed in either line, the voltage level translation is only 120VAC from Neutral. When the load voltage is 120VAC the control is still at Neutral and the power device is still on the high side line. FIG. 1 shows the typical placement of control circuitry at the Neutral potential where level shifting from 120 VAC will be used for both 240 VAC, line to line applications as well as 120 VAC line to phase applications.

This invention does not follow the above mentioned engineering standards. This invention places the power semiconductor device in series with either line 1 or line 2 and it places the computer section with the A to D conversion at this high voltage AC potential. All of the control circuitry is floating at the 120VAC potential. An entirely different set of design problems are created. While at the same time some special advantages are created for this invention. The first advantage is the reduced expense from minimal level shifting between the DSP unit output and the Power Device potential. The second advantage is that this invention now has the ability to accurately measure the voltage potential across the power device when it is turned on.

This invention breaks from tradition as it places the control circuit which includes a Digital Signal Processor (DSP) with Analog to Digital converters in series with the Hot/High Side AC line voltage. This is shown in FIG. 2. In FIG. 3, reference numeral 10 is where the common side of the control circuit is located. This directly corresponds with FIG. 11, reference numeral 10—AC Line voltage. With the circuit starting at this point, several unique features are possible with a reduced material cost.

The power semiconductor device has a forward voltage drop that is created by the current going through the device. This voltage drop is not automatically calibrated to a specific current through the device. The fact is that the current to VF ratio changes between devices and for the same device it changes over temperature. This invention actually uses the VF to replace a current signal from the commonly used current sense transformer. In other words, the current transformer 43 of FIG. 3 may be omitted if current measurement is not required, but significant current variations need to be detected to indicate a stepped load change or perhaps an overload condition. The VSS for the DSP device, the AC Line input voltage, and the power device input are all at the same voltage potential for this invention. The negative or ground side of the A to D converter is electrically connected to the power device input using a high impedance input. A single ended A to D input from the load side of the power device provides a voltage measurement across the device. During the normal operation of this invention, there are periods of time when the power device is turned off and a high AC voltage potential is present. There can be a ringing voltage when the part is first turned on. When the voltage has stabilized, a summation of several voltage measurements made before the device turns back off can be used to determine the relative current level through the device. The computer program will analyze this measurement, compare it to previous measurements, and store it for comparison later. From that, the invention can determine if the current is increasing, reducing, or remaining the same without the use (and expense) of a current sense transformer.

This invention can function without a current sense transformer and still detect relative current levels and quick changes in current levels caused by the load. Reference numeral 20 in FIGS. 3 and 11 is the voltage across the power thyristor. When the thyristor is on, the voltage at point 20 is the Forward Voltage (VF) drop caused by the current going thru the part to the load. Operational amplifier 25 buffers this signal and the other AC Line voltage signal (or Neutral voltage signal) with the outputs going to the DSP. Then operational amplifier 25 amplifies the buffered signal from point 20 and provides that signal to the DSP. This signal is used to measure the VF of the thyristor and derive the current level flowing through the load. Detecting the current level without a current sense transformer provides a significant advantage in terms of reduced parts count and cost for this invention. This voltage signal is seen in FIG. 4 along with a typical current sense transformer output for a low current load

As the current through the thyristor approaches zero, it reaches what is known as the minimum holding current and after that point, it turns off. When the part turns off, the voltage across it goes from the low VF which is less than 2 volts to a high AC Voltage potential. Detecting this large abrupt or sudden voltage change thus replaces the zero current crossing for the AC signal. It is not a low current level that we are trying to detect then but rather the result of that low level when connected to an inductive load. It should be noted that if the load was resistive with a unity power factor, the current and voltage would both be zero at the same time and this type of detection would not be possible or necessary. Both the AC Voltage crossing through the zero potential and the AC current crossing through zero are needed to determine if the motor load is getting the proper RMS AC Voltage. The present invention replaces the detection of AC current zero crossing with the detection of voltage across the thyristor. The method just described is much more accurate than looking at the output signal from a current sense transformer. While at full scale current the voltage signal from the transformer can be used to detect a zero current crossing, the accuracy is greatly reduced at lower current load levels. This invention uses the larger voltage change across the power device which is easier to detect and does not vary from high to low current loads. This greatly improves the accuracy of zero current crossing detection across the entire load range. Improved accuracy results in improved control and it is at a lower cost.

FIG. 4 shows the voltage waveforms present at the Analog to Digital (A to D) converter in the DSP. In FIG. 4, the line voltage 50 is shown relative to the line current 55 when the system of the present invention has not been implemented. The second wave form of FIG. 4 shows the line voltage 50 and the line current 55 as it appears when the present system is implemented to regulate the AC RMS voltage. The third wave form of FIG. 4 illustrates the voltage existing across the SCR showing the rapid voltage increase that may be used to mark the time of zero current cross-over in the system. The abrupt voltage that is detected at that point is the result of the turn off characteristic of the power SCR device—it goes through the holding current level and at that point in time it stops forward conduction and the reverse bias voltage that is across the part is seen across the part as quickly as the turn off voltage is capable of being displayed by the device characteristics. Referring now to FIGS. 3 and 4, the common point for the control circuitry is at 10 which is always a relative zero volts for the A to D converter; 20 is at the voltage level across the thyristor. The voltage between points 10 and 30 exhibits the sine wave from the opposite AC line voltage. Point 40 is the output of a current sense transformer 42.

As the current through the power thyristor reaches the minimum holding current for the thyristor, it will turn off regardless of the voltage potential across the thyristor. The voltage at that time tells many things about the load. If the voltage is low and it is at the same time as the line voltage crossing through zero, then the load is very resistive with a power factor near one and there is very little negative energy. If however the voltage is high and there is a time delay between the voltage crossing and this control signal, then the load is inductive and there is some amount of wasted energy.

When the power thyristor turns off it waits to be turned on again by a gate drive current. The DSP processes all of the information and then provides an output signal at 46 which turns on the power device when desired. For a resistive load, this off time is determined by simply reducing the load voltage to a set AC RMS value which is normally close to the minimum AC voltage specification for the load.

For an inductive load the goal is to reduce the AC RMS voltage to a point where there is little or no time difference between the zero voltage crossing at point 30 and the voltage increase at point 20. Reducing the time difference between these two events reduces the wasted energy at the load. There is typically a maximum AC RMS voltage reduction.

The circuit shown in FIG. 11 uses a Texas Instruments DSP 27 with five Analog to Digital converter inputs. 25 is an operational amplifier sold by Analog Devices that provides a single supply device capable of working at 3.3VDC and providing rail to rail output signals. R1 and R2 form a voltage divider for ½ of the 3.3VDC level to be used as a reference voltage by the op amp when looking at the AC voltage. R3 and R4 provide the voltage level translation from the high AC voltage to a level that the DSP A to D can process. The output current from DSP 27 at terminal 1 is amplified by Q1 to provide enough current to turn on Q2. Q2 must be a sensitive gate TRIAC that works in all 4 quadrants so that the positive gate signal will turn the part on with either a positive or negative AC signal across Q2. Ti is the current sense transformer that provides an output across R5 that is proportional to the load current and can be calibrated for actual power measurements

For many residential and small business applications it is possible to locate a single controller near the breaker panel and have access to several AC loads from one physical location. One of these single phase multipoint load controllers can provide voltage control to individual loads using a single processor and A to D unit. The cost for controlling the voltage to multiple motors can be substantially reduced by using this single integrated system.

This invention provides total flexibility to the electrician as each single control section could be connected between either line and the load. It is even possible that a control section would be connected between either line and neutral (which is connected to ground). The only restriction is that the power supply is connected between the two power lines going into the building, This invention is then able to reduce the parts cost and count by keeping the A to D conversion/measurement negative reference (VSS) connected to one of the AC line inputs. One of the measurement channels is then used to measure the voltage on the other AC line input. The voltage levels need to be translated down from the high AC line voltage and buffered for the Analog to Digital conversion. Every load has just one input to the A to D and that is from the load side of the semiconductor device. Any load connected to the same line as VSS then uses the standard single phase program for detecting AC load voltage, Zero Voltage Crossing, and Zero Current Crossing. Every load that is connected to the other AC line voltage has the advanced math processor of the DSP perform mathematical calculation on the measured load voltage and the measured AC line voltage to derive the AC load voltage, Zero Voltage Crossing, and Zero Current Crossing.

The return side of the load will either be connected to the other AC line voltage providing 240VAC across the load or it will be connected to Neutral which provides 120VAC across the load. The A to D measurements taken on the load side are different between the two types of connections. This difference is accounted for in software which provides the ability to control both 120VAC loads and 240VAC loads. A significant difference for this invention is that the result provides total flexibility to the electrician for connecting any wire from the breakers to this AC Voltage controller for both 120VAC and 240VAC loads.

Current sense transformers can be placed to measure each load as well as the two AC lines directly after the utility company power meter. With this configuration the invention can control both the AC Voltage and the demand side load level. Some utility companies already have rate plans that charge based on peak demands and more utility companies are planning on implementing plans like that. This invention monitors the AC input line voltage for both lines. Using current sense transformers on each input line this unit measures total current and calculates both instantaneous and running average power demands in terms of KVA and KW. The individual loads being controlled can then be turned off and on as required to meet total load demands.

The single phase multipoint load controller embodiment is shown in FIG. 5. The circuit in FIG. 5 uses a DSP that has more A to D inputs. The one presently used has 16 A to D inputs. The power supply uses the two line input AC voltages and places the negative side of the supply voltage on one of the line potentials. In providing flexible product applications that the electrician can connect between either line and a load, the power Thyristors must be isolated from the incoming live voltage. For example, photo-couplers may be used in place of Q1 of the single phase FIG. 11.

FIG. 5 point 51 then is connected to either line voltage after the circuit breaker. Point 52 is connected to the load that would normally connect to the circuit breaker. The opposite side of the load is either the other line voltage or Neutral/ground. Power for the multipoint controller is provided using a dedicated 240VAC circuit breaker. By having the control circuitry at the same AC potential as one line and by measuring the opposite line potential with an A to D input, both possibilities are known by the DSP.

An A to D input is then needed from each load side connection and the control circuitry will function properly. A current sense transformer 53 is used for load control applications where a specific current level is being controlled. Load control applications completely turn off different loads for different periods of time to keep the peak current demands below some set value. Load leveling options are obtained by simply adding the additional software to this single phase multipoint controller.

Information can be valuable, even on these single phase controllers. This invention includes human interface communications as well as the ability to communicate between the controllers. A typical single phase controller connected to a pump motor or an air handling unit could communicate valuable information to the owner.

The swimming pool pump motor is single phase and this invention could determine that the current has increased due to heavier loads. Communicating this to the owner could be an alert that the pump filters are clogged and need to be cleaned. It is the same type of information for an air conditioner that could let the owner know to check the air filters. In special applications a sharp increase in current could indicate a mechanical jam that could harm the product or create a hazardous environment for humans. The ability to quickly communicate this to humans that could then take action, or to other computerized control systems that could take a predetermined corrective action is important and potentially valuable.

The multipoint load controller also communicates to the electrician who is configuring it using a computer terminal. During its normal use, it communicates to intelligent thermostats inside the home or other facility as it interacts with the end users.

The communications include information such as the time of day, day of the week, month of the year, and which year it is, the start and stop times for peak and non-peak rate plans, temperature settings for time of day & day of week, the present power demand as well as recent average and historical demands, the peak KW/KVA demand to control the voltage loads to, the minimum and maximum on and off times for each controlled load, how well it is performing and the savings obtained, how balanced the loads are between the phases, and normal loads can be defined and alerts set for potential problems.

The first communications capability is shown in FIG. 3 point 27 and FIG. 11 point 29. This two wire output port from the DSP is normally configured for RS-232 serial communications. This works fine for the human interface to a PC or like device. Networking is also possible using fairly standard or semi-custom hardware. The 7 layer OSI model is used to describe the various layers between the physical (at the lowest end) and the application (on the highest end of the model). Using that standard model, it is the session and application model software that will vary for this invention. The other layers including the TCP/IP layers will work well for sending and receiving information between controllers and a site master if present. An expanded data model for the information sent is included in the Software Description.

The majority of the AC voltage supplied to factories in the USA is 3 Phase 480 VAC. The 480V potential is seen phase to phase. The voltage potential between any phase and Neutral is 277VAC. Some loads, like the typical florescent lights, are normally connected between phase and ground using 277VAC. Lighting loads especially are not balanced between the phases. The voltage controllers for these loads are connected to the 3 phase AC input; however, they treat the loads as if each one is independent. A few restrictions for how the electrical connections must be made. The power supply uses a 3 phase input transformer which is connected to the input side of the 3 control circuits. The output sides of the 3 control circuits are connected to the 3 loads which are then connected to Neutral.

This controller type is shown in FIG. 6 with a typical application that is controlling voltage for florescent lights. In the United States and many other countries, 480VAC 3 phase AC power is common. The 480VAC is measured between any 2 phases. If a voltage measurement was taken from any phase to ground, the measurement would be close to 277VAC. The number of lights connected to any one phase is not the same as what might be connected to another phase. Any one or more loads on a phase may even be turned off which unbalances loads. With unbalanced loads, the controller treats the output of each phase as an individual load.

This controller circuit has many of the features found in the single phase multi-point load controller as well as some found on the 3 phase controller. Like the multipoint load controller, this embodiment is also used to control three individual load voltages. Like the 3 phase controller, the control circuit has a common reference at point 61 on FIG. 6. This is the B phase AC input line. The negative side of the power supply is connected at this point. The line voltage for the other 2 phases as well as Neutral is measured by the A to D converter. In FIG. 6, this is shown at points 63, 65 and 64. The control signal developed across the thyristor is directly measured across Q6. The voltages across Q5 and Q7 are determined mathematically from measurements on both sides of the devices.

The 3 phase motor controller builds on the success of the single phase motor controller. The first notable similarity is that there are no connections to neutral or ground, just the 3 power phases. The control circuitry resides on the “B” phase power input similar to the control circuitry connection used in the single phase system described above. This makes the AB and BC phase voltages direct measurements however the CA phase voltage is calculated mathematically.

The current sense transformer alternative described in connection with the single phase embodiment above also applies to this 3 phase controller as we measure the on state voltage of the phase B thyristor to derive the relative current level going through the controller.

The zero current crossing detection described in connection with the single phase embodiment above also applies to this 3 phase controller. Measuring the stepped increase voltage across the phase B thyristor is just as easy and accurate as it is in the single phase controller. Voltage measurements from both sides of the phase A & C thyristors are being taken using the A to D converter. The delta voltage mathematically calculated is used for the A and C phase zero current detection.

The communications described above in connection with single phase applies to the 3 phase controller also. This controller has both the human interface and the network interface to other controllers using protocols such as BACnet Ethernet or DEVICEnet.

FIG. 7 shows the three phase AC motor controller. The DSP circuit for this controller is also located at the same potential as the input side of phase B at 71. The direct measurement is taken for the voltage across Q3, at 71 and 72. Mathematical calculations are used for the measurements across Q2, at 75 and 76 as well as for the voltage measurement across Q4, at 73 and 74.

All three phases connect to a single load for this controller so the desire is to have each phase with an equal RMS AC Voltage being applied. The input voltage may not be balanced and that leads to an imbalance in the current through the motor windings of the 3 phases. This controller will balance out the current and voltage among the three phases as it reduces the overall RMS voltage to meet the needs of the motor load. When the voltage is nearly equal on each phase it allows the system to properly react to load changes when only the B phase current is being monitored using the above alternative to current sense transformers.

FIG. 7 shows current sense transformers at 77, 78 and 79. These are not needed to perform the basic control functions, however they are needed if actual calibrated power measurements are desired for the load being controlled. Adding the current sense transformers and calibrating the feedback circuits allows the controller to provide full power metering in addition to the standard voltage control.

Both a user graphical user interface (GUI) as well as a communications output used for networking are provided. The user interface is a display and a simple keypad used for selecting and updating information used by the processor. The dedicated network communications is offloaded to a co-processor with communications between the two processors using a standard Serial Peripheral Interface (SPI). Buffering may be desired between the two processors SPI memory chips. This allows the DSP to operate in real time for the AC motor control and the network processor to operate on timing synchronized to the network.

The site manager performs many functions that are dependant upon how it is configured. It will perform for 3 phase controllers what the multipoint load controller described above does for single phase controllers. Three phase motors typically are controlled at a motor control center (CC) in larger industrial and commercial locations. The circuit breakers for the motors are distributed to what is called individual buckets where all of the special control for manual and automated running for each motor is placed in individual compartments. The site manager is located in the first motor control center for the site. This is where the power factor capacitors for the facility are also located. The site manager can then continuously monitor the voltage and current of each phase as it enters the facility. It will also communicate to each controller to monitor motor status, voltage control, and energy consumption. The standard industrial and commercial motor control features are available as well as many energy related control features. Motors will also be controlled based on energy cost and total facility energy consumption. The Utility Company will also be able to send information to the site controller regarding possible brown out conditions, rolling black out requirements and energy consumption cut back demands. All of this will require different control scenarios provided by the site manager.

This part of the overall invention performs two important functions. The first is to communicate with all of the point of use voltage controllers at a facility. Referring to FIG. 8, 80 is the network communications port. Information gathered from communicating controllers is used to help balance the AC loads within the facility. This information is also used to provide load leveling, reducing the peak AC Power demands for the facility. Information about the individual loads is tracked and analyzed to predict preventative maintenance requirements that can be used to increase the uptime for the facility.

The second important function is to automate the changing power factor capacitor requirements for a facility. Voltage measurements are taken for the 3 incoming AC lines/phases at 81, 82 and 83. Standard current sense transformers 84, 85 and 86 are used to measure the incoming AC current for each line/phase. This unit converts the AC signals to digital values using the A to D capabilities and then performs power calculations including power factor for each phase to phase pair. This information is used along with the load balance information and the information about which loads are being turned on and off for load leveling. The result is and accurate addition or reduction of capacitance between phases to meet utility company requirements when the loads at the facility continuously change

The AC motors are inductive so a facility that utilizes many motors needs to have additional power factor capacitors to improve the overall facility power factor to a level acceptable by the Utility Company. This is a variable capacitor bank that is under the control of the site master.

This unit is shown in FIG. 9. The physical size and implementation of this unit will vary depending on the size of the facility and the amount of capacitance needed to meet the local utility company power factor requirements. The Site Manager communicates with this unit as shown at 91 with instructions to add or remove capacitance. Points 92 and 93 in FIG. 9 represent two phases of the AC incoming power where this bank of capacitors will connect. 94 represents a minimum capacitance that is always connected to compensate for the minimum AC inductance present at the facility. Subsequent capacitors, such as capacitor 95 may be added to the system through operation of solid state switch 96. In some systems, electro-mechanical contactors may be used instead of solid state switches. The number of capacitors and the value for each is dependant on the range of change required at the facility.

FIG. 10 is a diagram of the present invention embodied in a facility-wide control system and shows how each of the controllers can work together controlling the voltage for different types of loads at different locations in a common facility. The site manager 100 is located where the 3 phase AC power is brought into the building or facility. This unit can provide all of the metering capabilities that the utility company meters provide and can be used to verify reading from the utility company. The site manager can be used to verify the energy savings effectiveness for each of the individual controllers throughout the facility. From the communications with all of the individual controllers, the site manager can also make recommendations to level the power loads between phases if needed. These functions are in addition to the Power Factor correction and load leveling explained above.

Most of the three phase loads will utilize the standard three phase controller 200. The lighting normally is single phase using one of the three phases power to ground and will use controller 300. The communications between the three phase controllers and the site manager can use a number of different mediums for the data transfer. The energy related information is being communicated to the site manager. Industrial or building automation control is being communicated from the site manager to the individual controllers.

Most of the office equipment and smaller motor loads will use single phase 120/240 VAC power that comes from a step down transformer connected to the higher 480VAC power. The single phase voltage controllers 400 communicate with the site manage sending and receiving the same information.

Measurement techniques and calculation routines may be provided by software programs constructed specifically for this task. The operation of the system, under control of the software may be described by referring to FIGS. 13-32 and the following description.

The basic operation of the system uses a synchronized software interrupt to gather data at a fixed periodicity relative to the incoming sine wave. Independent of this interrupt, a control executes repeatedly to achieve the desired control functions. The fundamental control is based on the phase angle relationship measured as the difference between the voltage and current zero crossings. In addition, finer control parameters are adjusted based on current level, the rate of change of the current level, and the current size of the delay cut.

The control process consists of a closed control loop that either increases or decreases the size of the delay cut based on the current and past states of the system. The primary control algorithm first monitors the current parameters. After a set period of time it adjusts the size of the cut up or down. The control parameters are the length of time between adjustments, the size of each adjustment, and the direction of the adjustment. The control loop makes use of all of these parameters to achieve the desired control response.

The primary control is based on the measured phase angle. This control phase angle is an averaged and filtered measurement of the phase difference between the voltage and current zero crossing events. This value determines the direction of the adjustment. If the parameter is below the lower limit of the dead band, the size of the delay cut will be decreased. If the parameter is above the upper limit of the dead band the size of the delay cut will be increased. No change will be made if the parameter falls within the dead band.

The period of time before the next possible adjustment is based on the current size of the delay cut. If the size of the delay cut is decreased, it is analyzed for follow-up action on the very next cycle of input voltage. If the size of the delay cut is increased, it is not analyzed for follow up action until some time following the adjustment. This time increases linearly as the size of the delay cut increases. If the size of the delay is not adjusted, the length of time before further analysis is a fixed value.

The size of each adjustment is determined based on the direction and rate of change of the measured RMS current value. Increases in the size of the delay cut are always in increments of 1 degree. The magnitude of the adjustment for decreases in the size of the delay cut is determined by measuring the direction and rate of any change in the measured RMS current. The filtered RMS currents for the three phases are averaged and for a measured increase less than 3% from cycle to cycle the magnitude of the adjustment is set to 1 degree. For an increase of 3-6% from cycle to cycle the magnitude of the adjustment is set to 2 degrees. For an increase of 6-10% from cycle to cycle the magnitude of the adjustment is set to 4 degrees. Any increase of more than 10% for a single cycle will cause a savings reset to minimum delay cut on the very next cycle.

A soft start function is used to apply a gradually increasing voltage to the load during startup. This is done by initializing the control with a maximum delay cut set. This allows current to flow for only a few degrees of the voltage sine wave. The resulting RMS voltage is a small fraction of the incoming voltage and results in a greatly reduced line current.

After a given time interval, the size of the delay cut is decremented allowing a slightly larger fraction of the incoming voltage to be applied to the load. This results in a slight increase in the current to the load. This process is continued until full voltage is applied and the load is running normally.

To eliminate the expense of current sensing transformers, a unique alternative is used to determine a sudden change in current flow to the load. When conducting, the SCR device has a small voltage drop across it that is proportional to the current flow through it. The percent change in voltage is a tiny fraction of, but proportional to, the percent change in current (i.e. a 100% change in current might be a 5% change in voltage and a 200% change in current would be a 10% change in voltage). This allows us to sum this measured differential voltage samples over nearly the entire period of time the device is conducting for an aggregate sum that can be easily used to determine changes in current flow.

The zero current crossing event is determined by comparing the differential voltage measured across the power device to a fixed threshold level. The power device line and load side voltages are read and compared and the difference measured. If the difference exceeds the threshold level for two cycles in a row, corresponding current level flag is set to indicate the zero crossing event has occurred. If the controller is in current control mode (normal operation) the motor control timing parameters are set at this event to ensure the proper delay time before initiating an on signal to the power device(s).

The single phase is the base software that most other versions are built from. This software runs in two distinct sections. The first is the primary control loop that continuously loops through execution of the main control functions. The second section is a software interrupt that executes with a fixed periodicity. This interrupt is where all data sampling and analysis occurs. Prior to executing the main loop, memory and peripheral initialization occurs. After this initialization, the main loop begins execution.

The Main Loop is made up of a series of procedure calls. These call the various control functions depending on detected condition of the input power and the load. This loop executes continuously approximately 5000-8000 times per second and is periodically interrupted during execution by the software interrupt (FIG. 13).

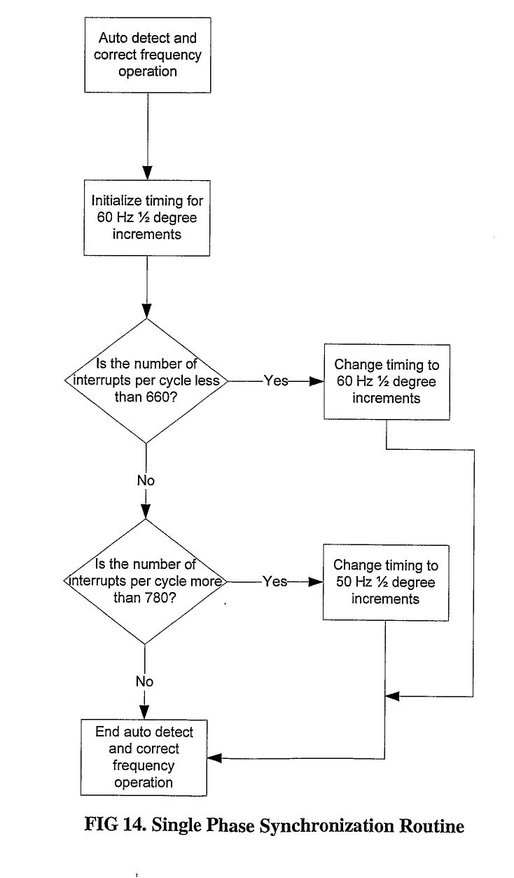

The Synchronization Routine monitors the status of the zero crossing event triggers and when a voltage zero crossing is detected a sequence of operations is performed. The frequency auto detection and timing compensation routine described previously is executed. Because this portion of the code only executes once per cycle, a counter is used to keep track of the number of cycles. Similarly, a counter keeps track of the number of seconds that have passed based on the number of cycles that have passed. Finally, during this routine, a fixed value equal to a current of 10% the rating of the unit is added to the current RMS current reading and stored. This value is calculated once per second and is used for later comparison to detect rising current conditions (FIG. 14).

The most common frequencies of electrical distribution are 50 and 60 cycles per second (Hz). The program initially assumes the frequency is 60 Hz and sets the interrupt timing for ½ degree increments across the full cycle wavelength.

The program monitors the number of interrupts that execute within a single cycle and if that number is too large, it means the line voltage is actually a 50 Hz signal. The interrupt period is then adjusted such that the ½ degree increments are maintained. If the interrupt timing is set for 50 Hz operation and the routine detects too few interrupts being executed within a cycle it means that the line voltage is actually a 60 Hz signal. The interrupt timing then adjusts such that the ½ degree increments are maintained.

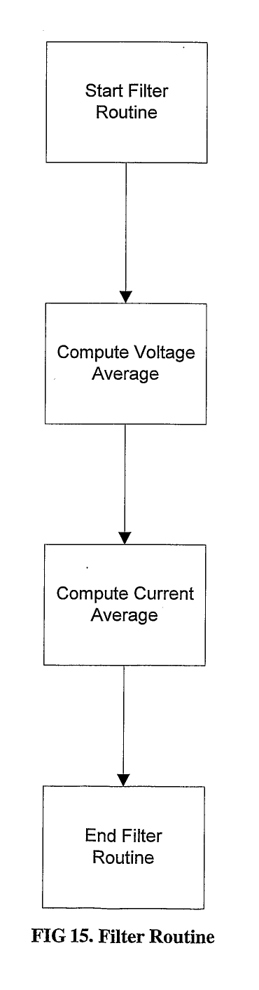

The Filtering Routine performs all averaging calculations for the RMS voltages and current signals. This routine will execute in its entirety once per cycle and performs a rolling average of the last eight values of each of the parameters (FIG. 15).

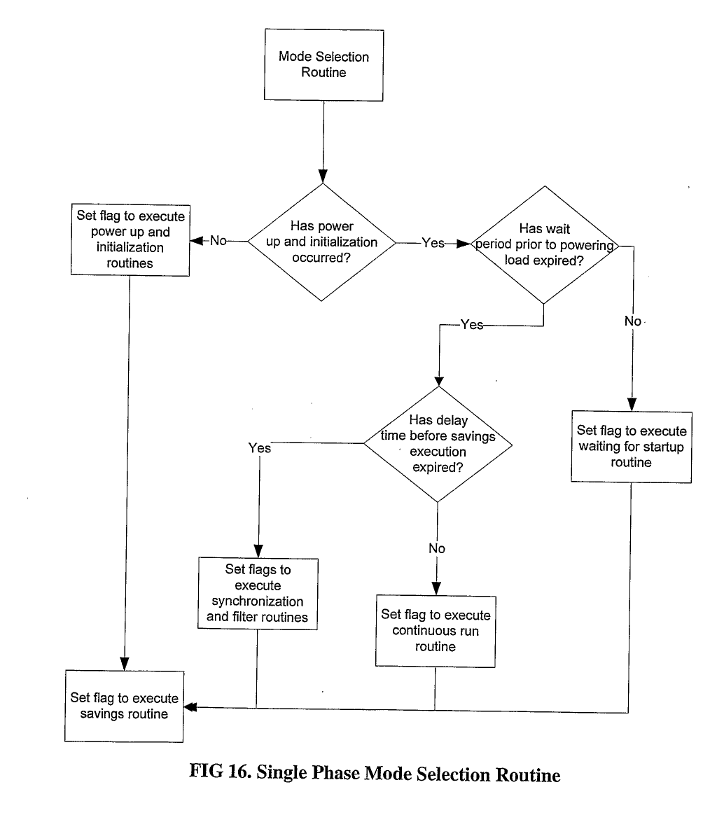

The Mode Selection Routine executes once every cycle and provides the majority of the control during operation. It ensures the proper sequence of operations is executed at startup and maintains active control over which sections of code run when. It initially verifies whether the initialization and power up routines have executed. If they have not, a flag is set to execute the power up and initialization routines. It then checks whether the wait period before starting the load has expired. If it has not yet expired, a flag is set to execute the waiting function. If the period has expired and all conditions are met, a flag is set to begin running the load. A check is then performed to verify if the required delay time prior to initiating the savings routine has expired. If it has not, a flag to execute the continuous run routine is set. If it has, a flag to execute the savings routine is set. Finally, flags are set to execute the synchronization and filter routine on every execution of the mode selection routine (FIG. 16).

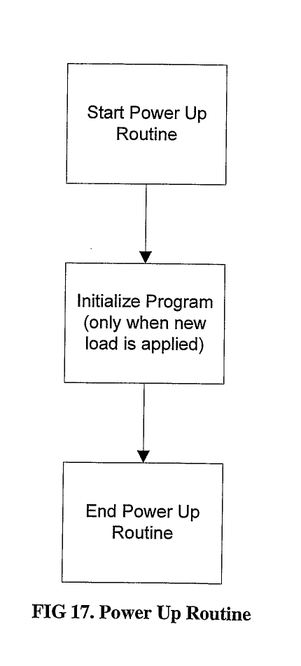

The Power Up Routine set necessary data fields to default values and establish the initial conditions for proper operation (FIG. 17).

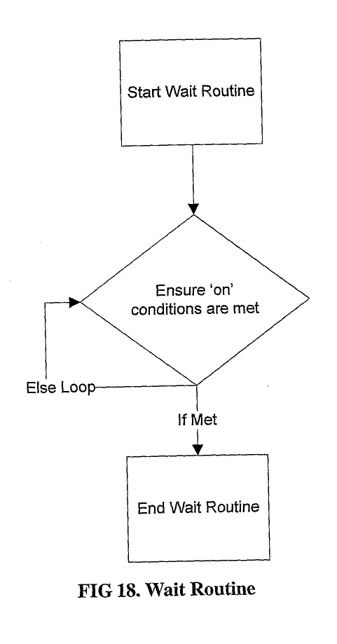

The Waiting Routine ensures that all conditions are met for proper operation of the load prior to allowing power to be applied to the load. It monitors the input voltage as well as the presence of a load that needs powering. If both these conditions are met, appropriate flags are set to begin applying power to the load (FIG. 18).

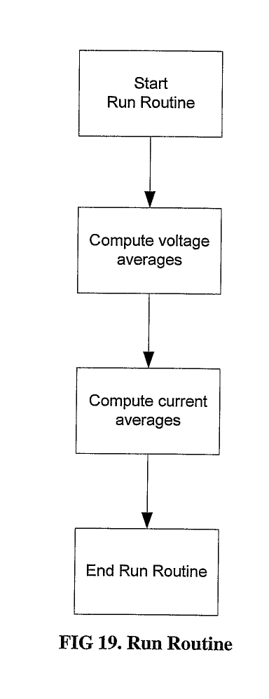

The Running Routine establishes the motor control timing parameters for minimal reduction in output voltage to the load. These timing parameters are what signal the motor control section of the interrupt when either an on or off signal must be sent to the motor drive circuitry (FIG. 19).

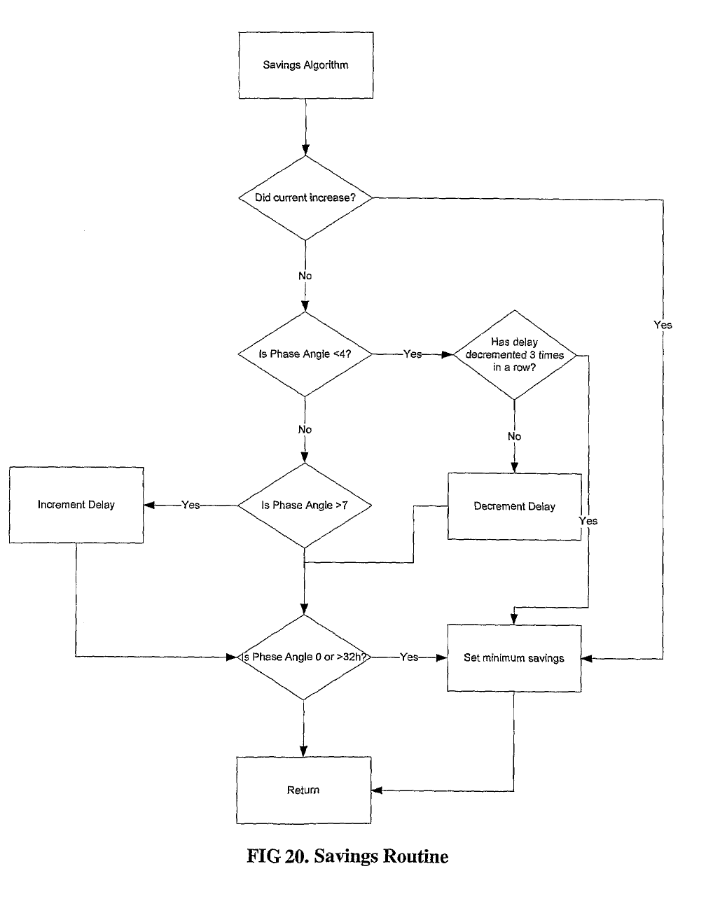

The Savings Routine executes once every cycle and is what detects and applies the appropriate voltage required for running the load under its current conditions. First, a check is performed comparing the most recent RMS current value to the limit established in the synch routine. If the current value exceeds the limit, the routine immediately sets the motor control timing for minimal delay (i.e. maximum output voltage). If the current value does not exceed the limit, the phase angle value is compared to predetermined set points. If the angle is too small, the delay timing parameters are decremented resulting in a higher output voltage. If a decrement has occurred three cycles in a row (indicating a rapidly increasing load), the timing parameters are immediately set for minimal delay. If the angle is too large, the delay parameters are incremented resulting in a lower output voltage. The final delay parameter is compared to certain limits and if these are exceeded, the parameter is reset to minimal delay. These limits should never be reached under normal execution and would represent a fault condition within the software execution. Resetting the limits reestablishes a normal control sequence (FIG. 20).

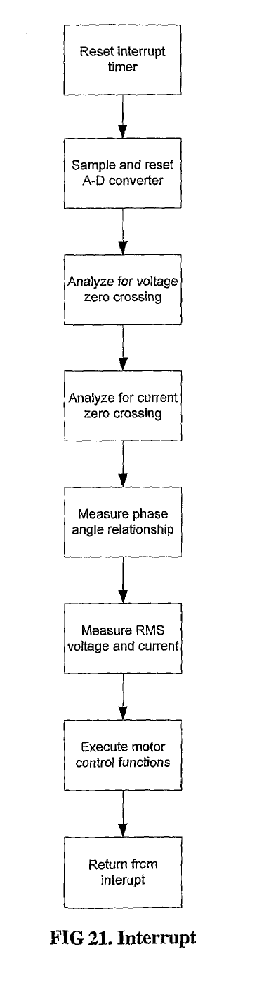

The Software Interrupt is used to synchronize the sampling and control of the motors. This interrupt is timed to execute with a fixed periodicity. The periodicity of execution determines the sampling resolution and accuracy of our parameter detection and varies depending on the processing required within the interrupt. The parameter detection and control functions require a synchronized and even distribution over the length of the voltage and current waveforms. To facilitate this, the interrupt periodicity was chosen as an integer fraction of the total cycle time. This allows us to automatically detect the line voltage frequency and adjust the interrupt period such that the distribution is always the same (FIG. 21).

The internal structure of the interrupt is constructed to execute sequentially the necessary detection and control routines. The first portion is devoted to resetting the timing for the interrupt itself. This ensures the proper periodicity of execution is maintained regardless of the exact execution path through the interrupt.

Once the timing has been reset, the interrupt is counted and the analog to digital sampled values are read and stored. The analog to digital converter is then reset to begin another sampling cycle.

The voltage and current samples are analyzed by comparing them against a known reference signal. Based on the results of this comparison, the presence of either a positive or negative going zero crossing event can be determined. If such an event has occurred, the event and the signal it occurred on are stored for future use.

Based on the periodic detection of voltage and current zero crossing events, the phase relationship between these two signals can be determined. The number of interrupts that occur between the detection of a voltage zero crossing and the detection of a current zero crossing is used to calculate the phase angle between the two. This value is then stored for future use outside the interrupt.

The root mean square values of the voltage and current signals are calculated by summing the absolute value of the difference between each sample and the reference signal over all samples collected for the given parameter over a single cycle. This summation provides a quantity that is proportional to the true RMS value of either voltage or current and is stored for use by other functions.

Finally the interrupt applies appropriate outputs to the motor drive circuits on the board. Based on timing parameters calculated and stored outside the interrupt, a determination is made as to the nature of the signal that must be sent to the drive circuitry. The results of this determination dictate whether an on or off signal must be sent and the appropriate signal is applied to the output pin.

Alternatively, this control can be executed by modifying the timing parameters in the on chip event manager. These parameters control a built in hardware pulse generator and can be adjusted to achieve the desired pulse timing for motor control with a much higher degree of resolution than the interrupt control

The single phase multipoint load controller is used to control 3 to 5 single phase signals coming from separate sources. This software is based off of the single phase software described in Single Phase Software Description. Again there are two distinct sections, the primary control loop that executes the main control functions and the software interrupt that measures motor signals.

The Main Loop makes the controlling procedure calls and differs from the single phase software only in that it sequentially executes the controlling routines Wait On, Run, and Savings for three to five separate signals. The fundamental operation is the same, utilizing a software interrupt for synchronizing events and an external control loop for executing the necessary control function.

Because a single DSP is used to monitor and control all the motors connected to the unit, the software must build an abstraction layer that completely separates each controlling section. Essentially the abstraction treats each motor as if it has its own CPU controlling it with separate control routines and individual execution paths through those routines for each motor load.

The Software Interrupt for the single phase multipoint load controller is very similar to the single phase software interrupt. The only real difference is that it must sample and control five different loads, each with its own load characteristics. Once sampling is complete, each load side voltage signal is compared to its respective line side voltage. As in the single phase, the zero crossing is marked if this difference exceeds the threshold setting. The phase angle relationship of each load is stored independently and the primary savings algorithm is applied to each load based on its determined condition.

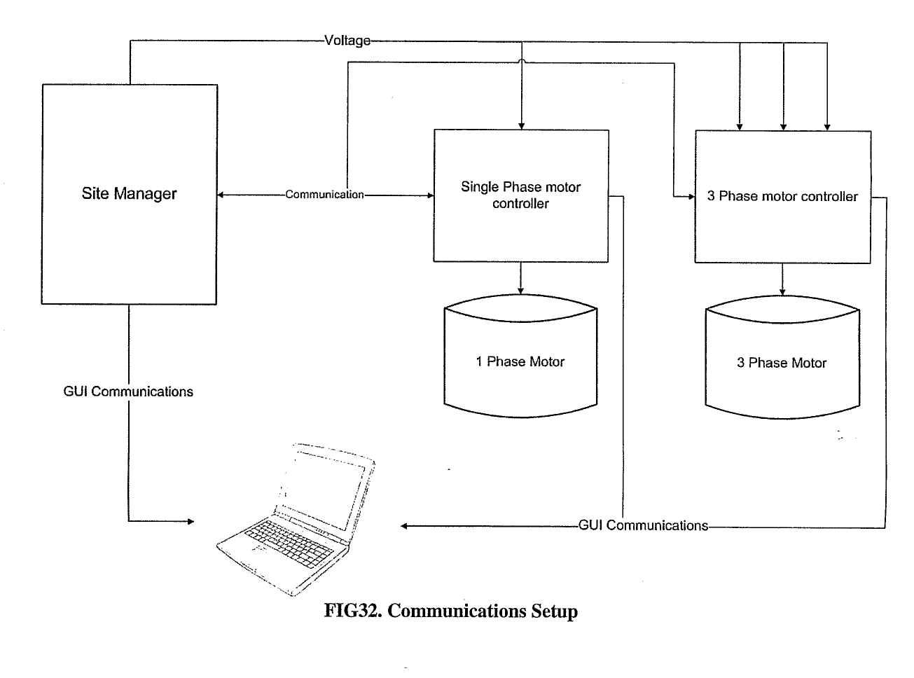

Communications routine serves two primary functions. One function is to transmit information directly to a connected laptop or desktop user interface from any of these units; site manager, single phase controller, 3 phase controller, single phase multipoint load controller, 3 phase individual load controller. The second function of communications is for units to transfer information to central site manager controllers (FIG. 32). The site manager tracks the status of all connected units and is discussed in the site manager section.

Direct board communication is used to transmit measurement and other important data from the power controlling unit to a laptop or desktop computer. Communication is initiated with a signal from the computer to the power device indicating a request of data. If the unit is busy communicating with another device (such as the site manager), the request return will be prolonged until the device is done. When the unit is ready it will return a list of data.

The three phase individual load control software is a modification of the single phase multipoint load controller software and runs similar to the three phase software with each leg controlled individually. The voltage across each SCR is used to determine the zero crossing of the current and the phase relationship of each of the three legs is measured and stored independently. The savings algorithm is then applied to the parameters of each leg and the delay cut set for the load requirements of each independent load.

The Main Loop makes controlling procedure calls and differs from the single phase multipoint load controller in that it will only control three loads. Each of these loads is monitored independently and the savings algorithm is applied via an abstraction layer similar to the operation of the single phase multipoint load controller.

The Software Interrupt for the 3 phase individual load runs similar to all the other controllers. It first samples all needed voltages and current signals. Each legs load side voltage is compared to the line side voltage and if a threshold is exceeded, a zero current crossing event is recorded. These events are compared with the corresponding voltage zero crossing event to determine the independent phase relationship of each leg. This phase relationship is what is used to apply the saving algorithm.

Based on the timing parameters set in the saving algorithm, the motor control circuitry for each load is turned on or off at the end of the interrupt. Alternatively, the built in hardware pulse generating feature can be used such that the timing parameters set in the savings algorithm control the automatic pulse generating output of the chip.

The three phase motor controller software is a modified version of the single phase software. This software is designed to control a 3-phase electric system. Again there are two distinct sections. The primary control loop (main loop) continuously loops through execution of the main control functions, and the software interrupt executes with fixed periodicity. This interrupt is where all data sampling of the three phase system occurs. Prior to executing the main loop, memory and peripheral initialization occurs, and then the main loop begins execution.

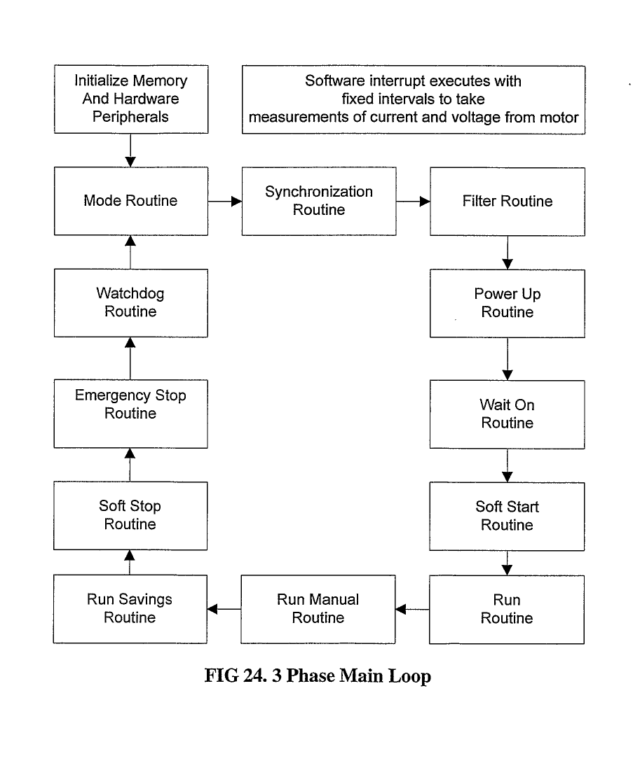

The Main Loop makes sequential procedure calls. These call the various control functions depending on detected condition of the input power and the load. Since the 3-phase keeps track of three signals it uses 1 degree intervals instead of ½ degree intervals. This loop executes continuously approximately 3000-5000 times per second and is periodically interrupted during execution by the software interrupt (FIG. 24).

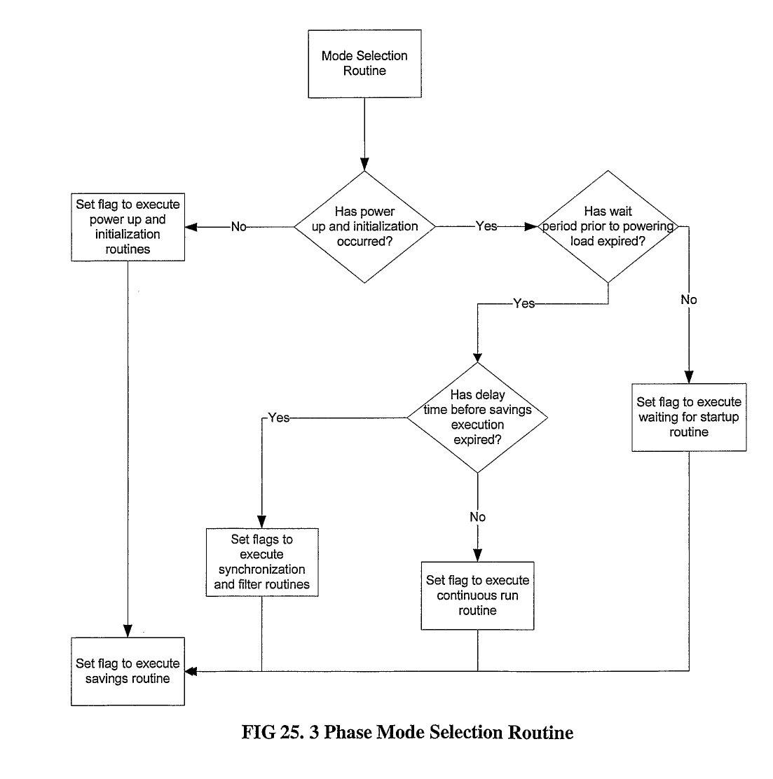

The Mode Routine executes once every cycle and provides the majority of the control during operation. It ensures the proper sequence of operations is executed at startup and maintains active control over which sections of code run when. It initially verifies whether the initialization and power up routines have executed. If they have not, a flag is set to execute the power up and initialization routines. It then checks whether the wait period before starting the load has expired. If it has not yet expired, a flag is set to execute the waiting function. Once the conditions are met for startup, a check is made to determine if soft start is desired. If so, a flag is set to initiate the soft start function. Once soft start is complete, a check is then performed to verify if the required delay time prior to initiating the savings routine has expired. If it has not, a flag is set to execute the continuous run routine. Once the delay has expired, a check is made to determine if manual savings is desired. If so a flag is set to initiate the manual savings routine. If automatic savings is desired, a flag is set to initiate the auto savings routine. Finally, flags are set to execute the synchronization and filter routine on every execution of the mode selection routine (FIG. 25).

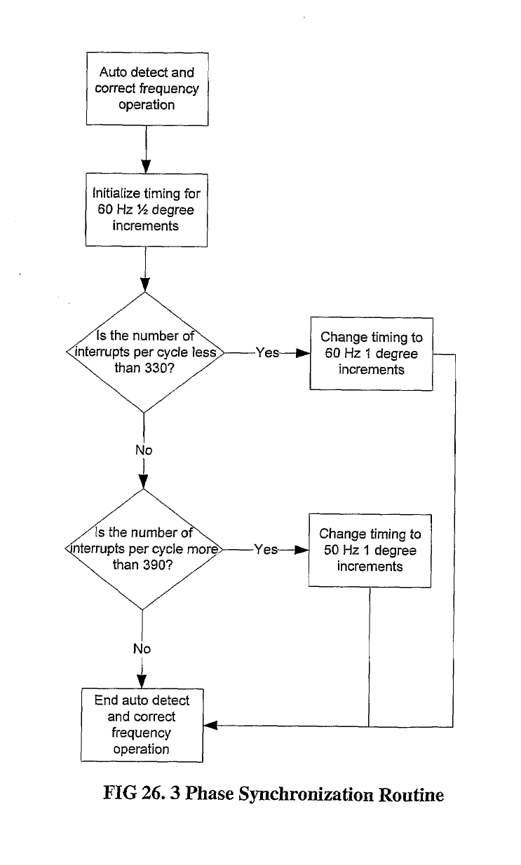

The Synchronization Routine monitors the status of zero crossing event triggers, and when an AB voltage zero crossing is detected it sets a flag to start a main control loop execution. A frequency auto detection and timing compensation function is executed. After this, external inputs are read and filtered to prevent false signals due to physical bouncing of the switches (debounced). The potentiometer readings are converted to the needed control parameters. Because this portion of the code executes once per cycle, a counter is used to keep track of the number of cycles. Similarly, a counter keeps track of the number of seconds that have passed based on the number of cycles that have passed. Finally, during this routine, a fixed value equal to a current of 10% the rating of the unit is added to the current RMS current reading and stored. This value is calculated once per second and is used for later comparison to detect rising current conditions (FIG. 26).

This program also assumes the frequency is 60 Hz and sets the interrupt timing for 1 degree increments across the full cycle wavelength. The program monitors the number of interrupts that execute within a single cycle and if that number is too large, it means the line voltage is actually a 50 Ez signal. The interrupt period is then adjusted such that the 1 degree increments are maintained. If the interrupt timing is set for 50 Hz operation and the routine detects too few interrupts being executed within a cycle it means that the line voltage is actually a 60 Hz signal. The interrupt timing then adjusts such that the 1 degree increments are maintained.

The external inputs are read and debounced by using two registers. The first holds the previous state of the input. On a given read, if the current state and the previous state are the same, the corresponding bit in the second register is set. This prevents spurious noise from initiating control events.

The potentiometer values are read from the analog to digital converter as a value from 0 to 1023. These values are then mathematically manipulated to derive the needed range of values for a particular control parameter. For example, the delay to savings is a value in seconds from 1 to 64 so the potentiometer value is divided by 16 and added to 1 to get the desired parameter.

The Filter Routine performs all averaging calculations for the RMS line and load voltages, RMS current, and phase angle measurements. This routine will execute in its entirety once per cycle and performs a rolling average of the last eight values of each parameter (FIG. 15).

The Power Up Routine runs a singe time when the system is first turned on and is used to initialize register values and settings needed for system operation (FIG. 17).

The Wait Routine ensures that all conditions are met for proper operation of the load prior to allowing power to be applied to the load. It monitors the input voltage as well as the presence of a load that needs powering. If both these conditions are met, appropriate flags are set to begin applying power to the load. This routine only runs when a load is started (FIG. 18).

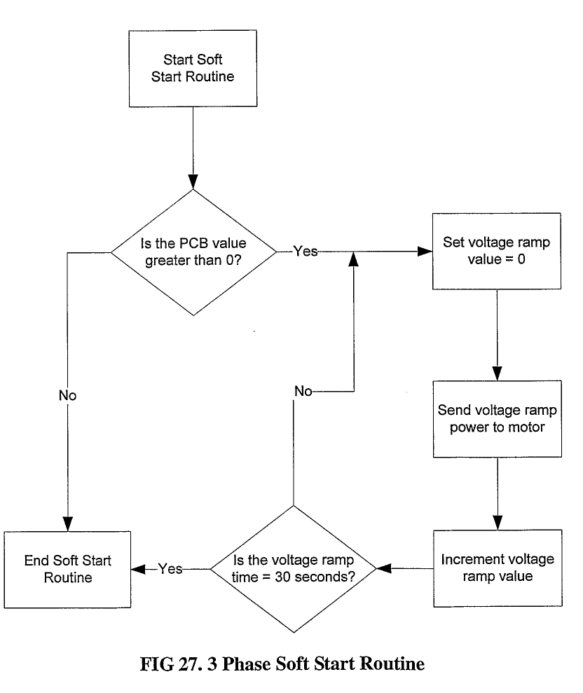

The Soft Start Routine uses a voltage ramp to slowly increase the power to the load and minimize the inrush current. Its operation is controlled via the manual adjust potentiometers on the PCB. If executed, the soft start function will run and provide a gradual voltage ramp to full voltage. Soft start will run a single time per cycling of the load and the set points of the ramp control can be changed at any time from the completion of the previous soft start up to the beginning of the next soft start (FIG. 27).

The Run Routine establishes the motor control timing parameters for minimal reduction in output voltage to the load. These timing parameters are what signal the motor control section of the interrupt when either an on or off signal must be sent to the motor drive circuitry (FIG. 19).

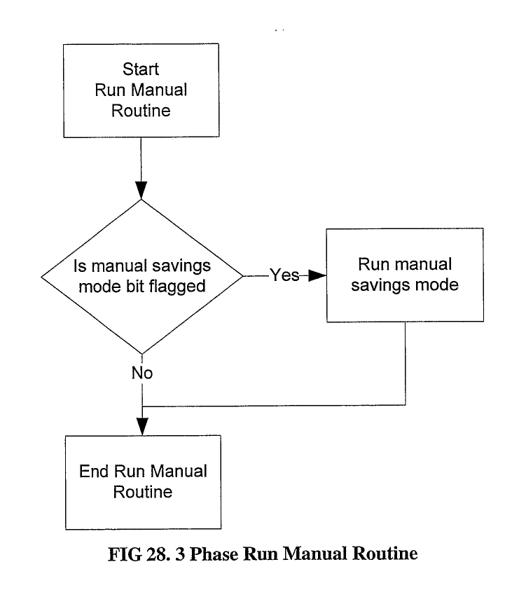

The Run Manual Routine is used to run the motor with manually set savings values. This is done by adjusting one of the potentiometers. It checks the manual savings flag once per cycle (FIG. 28) and if set, it sets the motor control timing parameters to the value determined by the manual adjustment parameters.

The Run Savings Routine executes once every cycle and is what detects and applies the appropriate voltage required for running the load under its current conditions. First, a check is performed comparing the most recent RMS current value to the limit established in the synch routine. If the current value exceeds the limit, the routine immediately sets the motor control timing for minimal delay (i.e. maximum output voltage). If the current value does not exceed the limit, the phase angle value is compared to predetermined set points (FIG. 20).

If the angle is too small, the delay timing parameters are decremented resulting in a higher output voltage. If a decrement has occurred three cycles in a row, the timing parameters are immediately set for minimal delay. If the angle is too large, the delay parameters are incremented resulting in a lower output voltage. The final delay parameter is compared to certain limits and if these are exceeded, the parameter is reset to minimal delay. These limits should never be reached under normal execution and would represent a fault condition within the software execution. Resetting the limits reestablishes a normal control sequence.

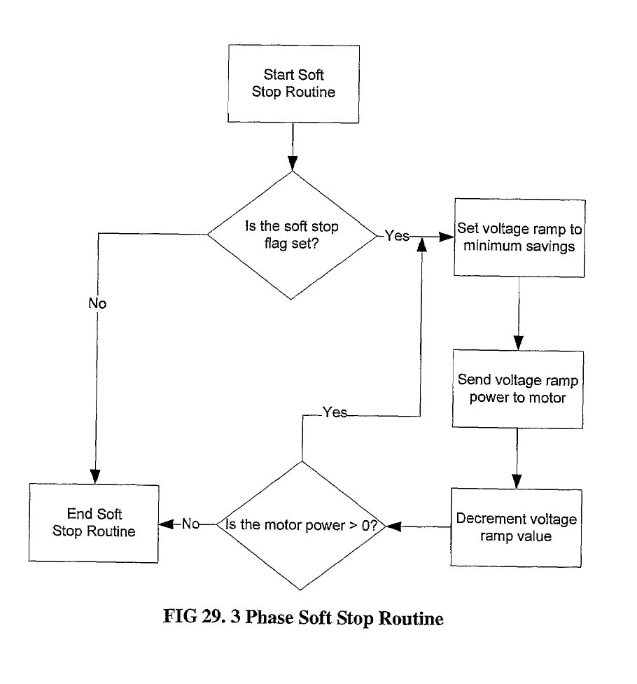

The Soft Stop Routine is used to power down the motor using a ramp down voltage counter that slowly backs off the power going to the motor. It runs in a loop that slowly decrements voltage ramp counter that is used to increase the savings values that control the motor. This loop executes until the motor shuts down (FIG. 29).

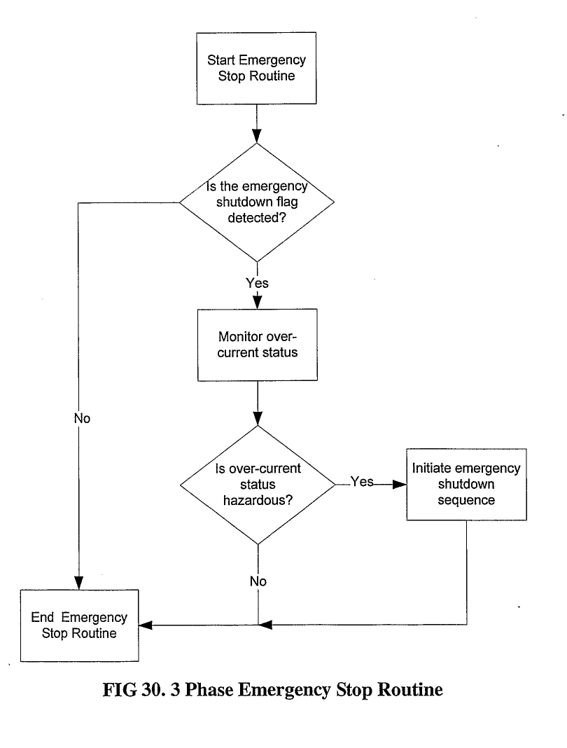

The Emergency Stop Routine is used to initiate and emergency shutdown sequence that cuts power the motor. This occurs when an emergency flag is set because of over-current detection. An over-current situation is monitored and the emergency shut initiated when hazardous current patterns detected (FIG. 30).

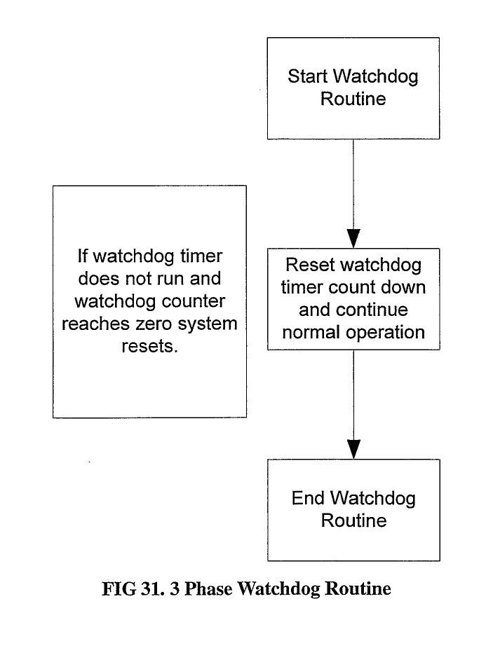

The Watchdog Routine provides monitoring of software execution and initiates a system reset if the software stalls (FIG. 31).

The Software Interrupt is used to synchronize the sampling and control of the motor(s). This interrupt is timed to execute with a fixed periodicity. The periodicity of execution determines the sampling resolution and accuracy of our parameter detection and varies depending on the processing required within the interrupt. The parameter detection and control functions require a synchronized and even distribution over the length of the voltage and current waveforms. To facilitate this, the interrupt periodicity was chosen as an integer fraction of the total cycle time. This allows us to automatically detect the line voltage frequency and adjust the interrupt period such that the distribution is always the same (FIG. 14).

The internal structure of the interrupt is constructed to execute sequentially the necessary detection and control routines. The first portion is devoted to resetting the timing for the interrupt itself. This ensures the proper periodicity of execution is maintained regardless of the exact execution path through the interrupt.

Once the timing has been reset, the interrupt is counted and the analog to digital sampled values are read and stored. The analog to digital converter is then reset to begin another sampling cycle. The stored values are analyzed to determine if a zero crossing event has occurred on either the voltage or the current.

The voltage and current samples are analyzed by comparing them against a known reference signal. Based on the results of this comparison, the presence of either a positive or negative going zero crossing event can be determined. If such an event has occurred, the event and the signal it occurred on are stored for future use.

Based on the periodic detection of voltage and current zero crossing events, the phase relationship between these two signals can be determined. The number of interrupts that occur between the detection of a voltage zero crossing and the detection of a current zero crossing is used to calculate the phase angle between the two. This value is then stored for future use outside the interrupt.

The root mean square values of the voltage and current signals are calculated by summing the absolute value of the difference between each sample and our reference signal over all samples collected for the given parameter over a single cycle. This summation provides a quantity that is proportional to the true RMS value of either voltage or current and is stored for use by other functions.

Finally the interrupt applies appropriate outputs to the motor drive circuits on the board. Based on timing parameters calculated and stored outside the interrupt, a determination is made as to the nature of the signal that must be sent to the drive circuitry. The results of this determination dictate whether an on or off signal must be sent and the appropriate signal is applied to the output pin.

Alternatively, this control can be executed by modifying the timing parameters in the on chip event manager. These parameters control a built in hardware pulse generator and can be adjusted to achieve the desired pulse timing for motor control with a much higher degree of resolution than the interrupt control.

The site manager software serves two primary functions. The first function is to communicate with individual motor controllers. This communications keeps track of each unit's status, and various control functions can be executed dependent on this status.

The second function of the site manager software is control the power factor capacitance controllers that adjust the phase angle relationship on incoming lines. This is done by measuring the incoming line voltages at connection points. The site manager uses these measurements to detect and adjust the phase angle difference between voltage and current with the standard PF capacitance controlling method.

I claim:

1. An AC voltage regulator system for controlling the RMS AC voltage to a load from a power source at a line voltage, the improvement comprising:
a. a switching device connected in series between the power source and load, said device responsive to a triggering signal for switching; and
b. a controller connected to said power source and floating at the line voltage, said controller connected to said switching device for providing said triggering signal thereto.

2. The AC voltage regulator system of claim 1 wherein said switching device is a silicon control rectifier.

3. The AC voltage regulator system of claim 1 wherein said controller is a thyristor.

4. The AC voltage regulator system of claim 1 wherein said controller includes a digital signal processor and an analog to digital converter for generating said triggering signal.

5. An AC voltage regulator system for controlling the RMS AC voltage to a load from a power source at a line voltage, the improvement comprising:
a. a switching device connected in series between the power source and load, said device responsive to a triggering signal for switching; and
b. a controller connected across said switching device and responsive to abrupt voltage increases across said switching device for timing any delay between line voltage zero cross-over and line current zero cross-over to generate a triggering signal for application to said switching device.

6. The AC voltage regulator system of claim 5 wherein said switching device is a silicon control rectifier.

7. The AC voltage regulator system of claim 5 wherein said controller is a thyristor.

8. The AC voltage regulator system of claim 5 wherein said controller includes a digital signal processor and an analog to digital converter for generating said triggering signal.

9. In an AC system having a power source at a line voltage and a load, current measuring apparatus comprising:
a. a switching device connected in series between the power source and the load, said device when off blocking the flow of current to the load and permitting the flow of current when on;
b. a controller including a digital signal processor and A to D converter connected across the switching device; and
c. said controller programmed to measure voltage across the switching device when switched on to provide a signal corresponding to line current.

10. The AC voltage regulator system of claim 9 wherein said switching device is a silicon control rectifier.

11. The AC voltage regulator system of claim 9 wherein said controller is a thyristor.

12. The AC system as set forth in claim 9 wherein said controller includes a digital signal processor and an analog digital converter for generating the signal corresponding to line current.

13. An AC voltage regulator system for controlling the RMS AC voltage to a plurality of loads from a single phase power source at a line voltage, the improvement comprising:
a. a plurality of switching devices each connected in series between the power source and a respective load, said devices responsive to a triggering signal for switching; and
b. a controller connected to said power source and floating at the line voltage, said controller connected to the load side of each of said switches.

14. The AC voltage regulator system of claim 13 wherein said switching device is a silicon control rectifier.

15. The AC voltage regulator system of claim 13 wherein said controller is a thyristor.

16. The AC voltage regulator system of claim 13 wherein said controller includes a digital signal processor and an analog to digital converter for generating said triggering signal.

17. In an AC circuit having a power source, a load, and a switching device in series between the power source and load, a method for regulating the RMS voltage applied to said load comprising:
a. detecting zero voltage cross-over of the power source voltage;
b. detecting any sudden increases in the voltage across said searching device; and
c. generating a triggering signal to turn the switching device on to reduce the time between the occurrence of the zero voltage cross-over and the sudden voltage increase across the switching device.

18. A method for measuring current in an AC voltage regulation circuit having a power source and a load comprising:
a. connecting a switchable device in series between said power source and load;
b. triggering said switching device on to permit current to flow through said switch to said load; and
c. measuring the voltage drop across said switch while said current is flowing to derive a value corresponding to current.

19. The method for measuring current in an AC voltage regulation circuit set forth in claim 18 including the additional stops of:
storing the measurement of the voltage drop across the switch while current is flowing therethrough; and
comparing the measurement to previous measurement to determine if the current is increasing, decreasing, or remaining the same.

20. An AC voltage regulator system for controlling the RMS AC voltage to a load from a power source at a line voltage, the improvement comprising:
a. a switching device connected in series between the power source and the load, said device when off blocking the flow of current to the load and permitting the flow of current when on;
b. a controller connected across said switching device and responsive to abrupt voltage increases across said switching device for timing any delay between line voltage zero cross-over and line current zero cross-over to generate a triggering signal for application to said switching device; and
c. said controller programmed to measure voltage across the switching device when switched on to provide a signal corresponding to line current.

21. An AC voltage regulator system for controlling the RMS AC voltage to a load from a power source at a line voltage, the improvement comprising:
a. a switching device connected in series between the power source and load, said device responsive to a triggering signal for switching; and
b. a controller connected across said switching device and responsive to abrupt voltage increases across said switching device for timing any delay between line voltage zero cross-over and line current zero cross-over to generate a triggering signal for application to said switching device, the controller connected to said power source and floating at the line voltage.

22. An AC voltage regulator system for controlling the RMS AC voltage to a load from a power source at a line voltage, the improvement comprising:
a. a switching device connected in series between the power source and the load, said device when off blocking the flow of current to the load and permitting the flow of current when on;
b. a controller including a digital signal processor and A to D converter connected across the switching device; and
c. said controller programmed to measure voltage across the switching device when switched on to provide a signal corresponding to line current, the controller connected to said power source and floating at the line voltage.

23. An AC voltage regulator system for controlling the RMS AC voltage to a load from a power source at a line voltage, the improvement comprising:
a. a switching device connected in series between the power source and the load, said device when off blocking the flow of current to the load and permitting the flow of current when on;
b. a controller including a digital signal processor and A to D converter connected across the switching device and programmed to measure voltage across the switching device when switched on to provide a signal corresponding to line current; and
c. said controller also connected to said power source and floating at the line voltage and responsive to abrupt voltage increases across said switching device for timing any delay between line voltage zero cross-over and line current zero cross-over to generate a triggering signal for application to said switching device.
